(19) United States
(12) Patent Application Publication
(10) Pub. No.: US 2004/0083256 A1
(43) Pub. Date: Apr. 29, 2004

(54) System and method for real time image transmission monitoring

(75) Inventor: Shao-Ning Chang, Taipei (TW)

Correspondence Address: Richard P. Berg, Esq., c/o LADAS & PARRY, Suite 2100, 5670 Wilshire Boulevard, Los Angeles, CA, 90036-5679, US

(73) Assignee: ICP ELECTRONICS INC.

(21) Appl. No.: 10/408,063

(22) Filed: Apr. 4, 2003

(30) Foreign Application Priority Data
Oct. 24, 2002 (TW) 91124775

(51) Int. Cl. G06F 15/16; G09G 5/00

(52) U.S. Cl. 709/200; 345/2.1; 710/15

(57) ABSTRACT

A system for real time image transmission monitoring for use in a network system connecting a server and a client. The system includes a remote image monitoring system having a VGA signal-gathering module to gather first and second frames from a client, and a VGA signal-gathering module. The VGA signal-gathering module defines each frame into a plurality of sub-frames, and numbers each sub-frame. Then, the contents of the sub-frames with the same number in the first and second frames are compared, and the content of the variation sub-frame in the second frame and its corresponding number are output to the server if the contents are different. The server replaces the content of the sub-frame with the number in the first frame by the received content, and thus forms the second frame to output.

### BACKGROUND OF THE INVENTION

1. Field of the Invention

The present invention relates to a system and method for image transmission monitoring, and particularly to a system and method for real time image transmission monitoring that reduces bandwidth used in transmission, thereby optimizing network traffic and speeding transmission.

2. Description of the Related Art

Using network techniques to monitor a remote computer or a peripheral device, such as a Keyboard, Voice or Mouse (KVM) has become a common practice in monitor systems. FIG. 1 shows a conventional remote image monitoring system, which manages clients via a KVM bus of a host 11 (server). Users can use server switches to monitor the image of the computer systems (clients 13 and 14) in the LAN (Local Area Network) and WAN (Wide Area Network) through a network interface 12.

The conventional system employs full screen transmission, that is, the client transmits a full image with or without compression to the server in a fixed frequency (frame/sec). Since the image data is always large, the transmission engages a lot of network bandwidth and results in increased network traffic, thus the object of real time monitoring cannot be realized.

Therefore, some conventional systems deploy a motion detection system in the client to detect and calculate the variations between two successive frames, and only transmit the variant portion to the server. Since the region and the size thereof of the variant portion are uncertain, the client has to perform complicated mathematics to calculate the variation block (motion portion). In such case, the load on the client becomes heavier, requiring addtional hardware support. Further, the client needs much time to calculate the variation block, and the efficiency of real time monitoring is decreased relatively.

In addition, the conventional systems recognize noise in the image as a variant portion. If there is much noise in different positions of the image, the variation block may contain a large area, and therefore delay the transmission.

### SUMMARY OF THE INVENTION

It is therefore an object of the present invention to provide a system and method for real time image transmission monitoring that optimizes network traffic to reduce bandwidth used in transmission, thereby speeding transmission and update the remote monitor image in real time.

To achieve the above object, the present invention provides a system and method for real time image transmission monitoring. The system includes a network system connecting a server and a client, and a remote image monitoring system. The remote image monitoring system includes a first network interface connected to the network system, a VGA signal-gathering module to gather a first frame and a second frame composed of VGA signals from the client according to time sequence, a first data storage device, and an image signal monitor unit.

The image signal monitor unit divides each frame into a plurality of sub-frames, and numbers each sub-frame according to its corresponding position. Then, the image signal monitor unit compares the contents of the sub-frames with the same number in the first frame and the second frame. If the contents are different, the content of the sub-frame in the second frame and its corresponding number are output via the first network interface through the network system to the server for display.

The server includes a second network interface connecting the network system, a second data storage device to record the first frame, an image update/replacing unit, and a terminal. The image update/replacing unit receives the content of the sub-frame in the second frame and its corresponding number from the remote image monitoring system via the second network interface, replaces the content of the sub-frame with the number in the first frame by the received content of the sub-frame, and displays the updated first frame on the terminal.

Further, a method for real time image transmission monitoring used in a network system connecting a server and a client is provided. First, a first frame and a second frame composed of VGA signals are gathered from the VGA card of the client according to time sequence. Then, each frame is divided into a plurality of sub-frames, and each sub-frame is numbered according to its corresponding position. Thereafter, the contents of the sub-frames with the same number in the first frame and the second frame are compared. If the contents are different, the content of the sub-frame in the second frame and its corresponding number are output via the first network interface through the network system to the server.

Afterward, a computer system of the server receives the content of the sub-frame in the second frame and its corresponding number via the second network interface, replaces the content of the sub-frame with the number in the first frame by the received content of the sub-frame, and the computer system can display the updated frame in real time.

### BRIEF DESCRIPTION OF THE DRAWINGS

The aforementioned objects, features and advantages of the invention will become apparent by referring to the following detailed description of the preferred embodiment with reference to the accompanying drawings, wherein:

FIG. 1 shows a conventional remote image monitoring system;

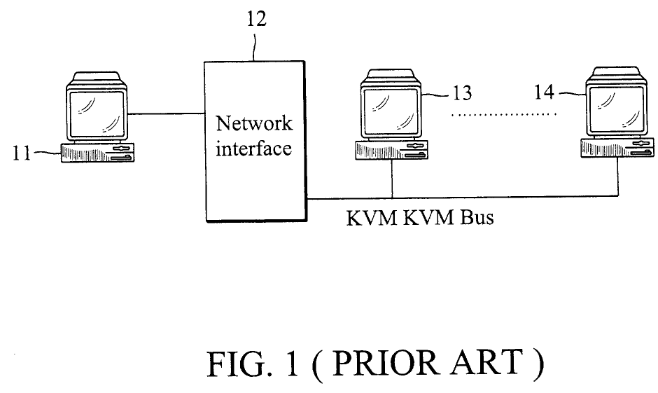

FIG. 2 is a schematic diagram illustrating the architecture of the system for real time image transmission monitoring according to the embodiment of the present invention;

FIG. 3 is a schematic diagram illustrating sub-frames divided from a frame; and

FIG. 4 is a flowchart showing the process of real time image transmission monitoring according to the embodiment of the present invention.

### DETAILED DESCRIPTION OF THE INVENTION

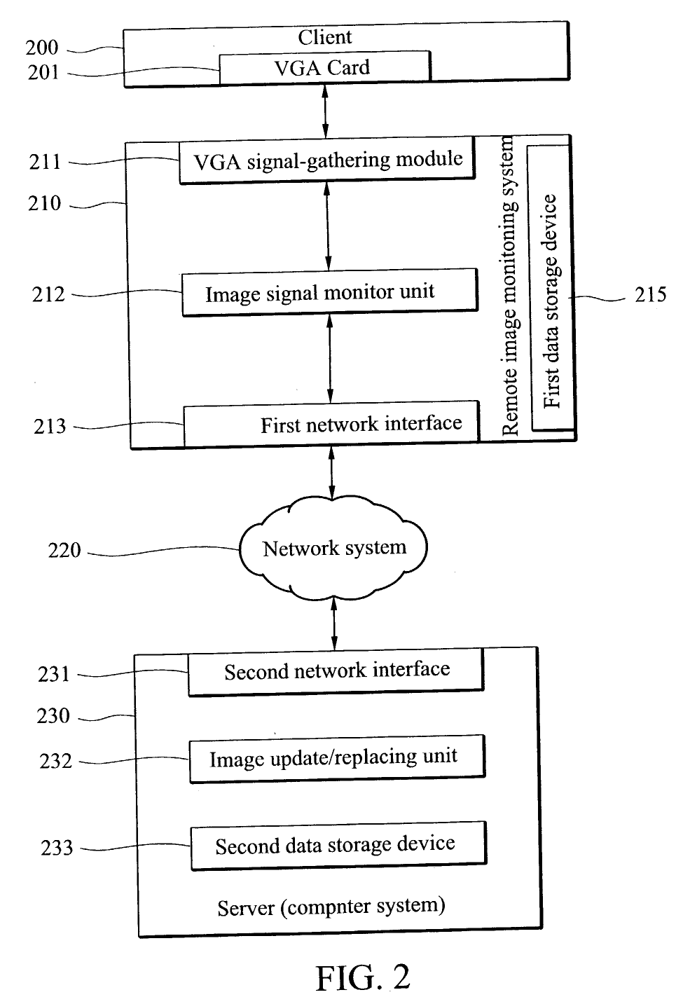

FIG. 2 illustrates the architecture of the system for real time image transmission monitoring according to the embodiment of the present invention. The system includes a client 200, a remote image monitoring system 210, a server 230, and a network system 220 connecting the client 200 and the server 230. It should be noted that the client 200 and the server 230 may be computer systems. The network system 220 may be Internet, LAN (Local Area Network) or WAN (Wide Area Network).

The client 200 deploys a VGA card (adapter) 201 or a display card to deal with the VGA signal of the client 200. The remote image monitoring system 210 includes a VGA signal-gathering module 211, an image signal monitor unit 212, a first network interface 213, and a first data storage device 215.

The VGA signal-gathering module 211 gathers frames composed of VGA signals, such as a first frame and a second frame generating a running sequence from the VGA card 201 of the client 200 according to time sequence. In this manner, the image signal can be directly gathered no matter whether the client 200 further employs an external image gathering device, such as a camera to monitor. Further, the first network interface 213 may be a network adapter to connect with the network system 220.

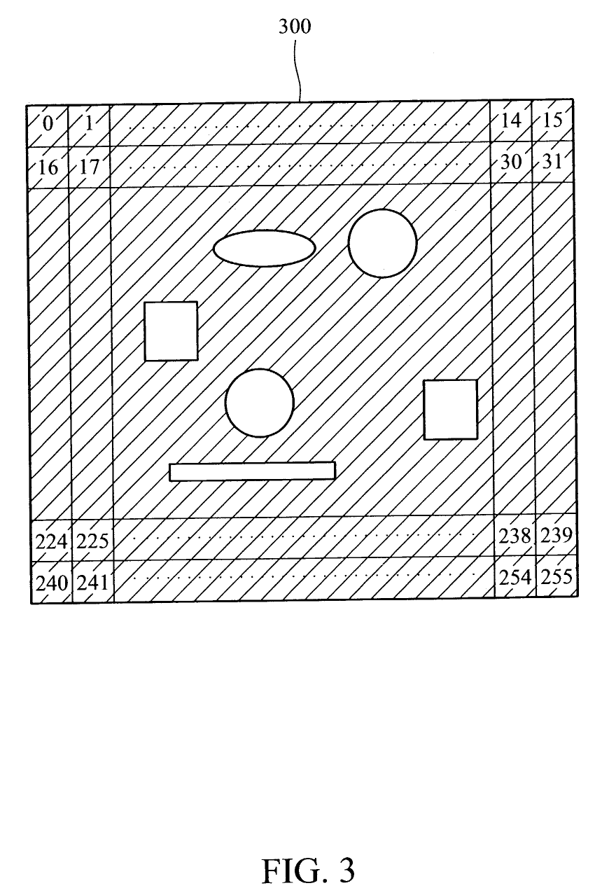

The image signal monitor unit 212 divides each frame into a plurality of sub-frames with the same size, and numbers each sub-frame according to its corresponding position on the frame. FIG. 3 illustrates an example of numbered sub-frames divided from a frame 300. In this case, the frame 300 is divided into 256 (16*16) sub-frames with number 0˜255 respectively. It should be noted that the number of sub-frames can be set on the image signal monitor unit 212, and the number of sub-frames may differ with application. In addition, the image signal monitor unit 212 compares the contents of the sub-frames with the same number in the first frame and the second frame. If the contents are different, the content of the variation sub-frame in the second frame and its corresponding number are output, in a data packet with a specific format, via the first network interface 213 through the network system 220 to the server for display. In this manner, the network bandwidth used can be reduced, and the transmission can be sped up.

The first data storage device 215 may be a flash memory to store software or firmware of the image signal monitor unit 212. After the determination described above, the subsequent received frame, such as the second frame, is stored into the first data storage device 215 to replace the prior frame (first frame).

The server 230 includes a second network interface 231, an image update/replacing unit 232, a second data storage device 233, and a terminal (not shown in FIG. 2). The second network interface 231 may be a network adapter to connect with the network system 220. The second data storage device 233 stores the frame, such as the first frame sent from the remote image monitoring system 210.

The image update/replacing unit 232 receives and identifies the data packet recording the content of the variation sub-frame in the second frame and its corresponding number sent from the remote image monitoring system 210 via the second network interface 231. The image update/replacing unit 232 replaces the content of the sub-frame with the number in the first frame by the received content of the sub-frame, and displays the updated first frame on the terminal. The updated frame is stored into the second data storage device 233.

According to the invention, the client 200 can be integrated into a KVM device, or a KVM bus can be integrated into the remote image monitoring system 210, such that several clients can be monitored and managed by the server synchronously.

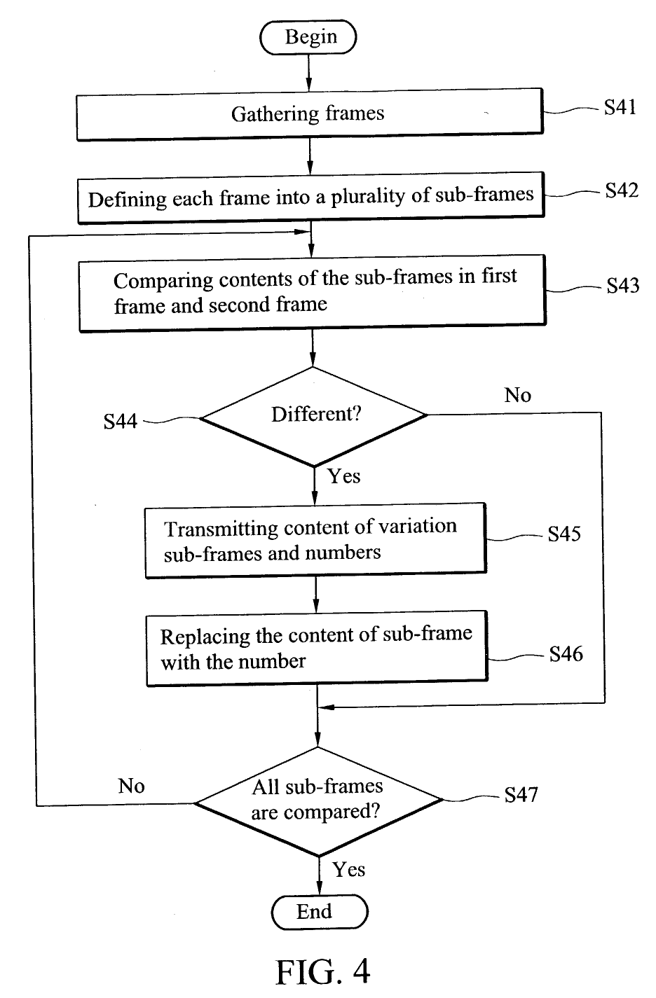

FIG. 4 shows the process of real time image transmission monitoring according to the embodiment of the present invention.

First, in step S41, successive frames are gathered from the VGA card 201 of the client 200 according to time sequence, in which the preceding frame is defined as a first frame and the later frame is defined as a second frame. Then, in step S42, each frame is divided into a plurality of sub-frames, and each sub-frame is numbered according to its corresponding position on the frame.

Thereafter, in step S43, the contents of the sub-frames with the same number in the first frame and the second frame are compared. If the contents are different (Yes in step S44), in step S45, the content of the variation sub-frame in the second frame and its corresponding number are output to the network system 220. After the server 230 receives the content of the variation sub-frame in the second frame and its corresponding number via the second network interface through the network system 220, in step S46, the content of the sub-frame with the number in the first frame is replaced by the received content of the variation sub-frame, and thus the computer system of server 230 can display the updated frame in real time.

Afterward, if all sub-frames are compared (Yes in step S47), the operation is finished, otherwise, the flow returns to step S43 for another sub-frame determination.

It should be noted that the variant sub-frames can be sent to the server individually or in combination with a predetermined quantity. In addition, since the video has a series of frames, the end of the operation discussed above only gives consideration to current frames (first frame and second frame), and other frames of the monitored video can be also applied to the operation of the invention.

As a result, using the system and method for real time image transmission monitoring according to the present invention, network traffic can be optimized to reduce bandwidth used in transmission, thereby speeding transmission and updating the remote monitor image in real time.

Further, the present invention has the following advantages. First, since the invention uses a fixed number of static blocks (sub-frames) to detect the variation between two frames, the variation block can be detected easily and quickly using a simple algorithm. Second, since only the compressed or uncompressed variation blocks and corresponding numbers have to transmit to the server, the network bandwidth used in transmission can be reduced significantly. In addition, the client does not require complicated operation in variation detection, thus the deployment cost of the client is reduced.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A system for real time image transmission monitoring, comprising:
a server having an image update/replacing unit;
a client;
a network system to interconnect between the server and the client; and
a remote image monitoring system to connect with the client electrically, the remote image monitoring system comprising:
a first network interface to connect with the network system;
a VGA signal-gathering module to gather a first frame and a second frame composed of VGA signals from the client according to time sequence; and
an image signal monitor unit to perform variation detection operation, the operation comprising the steps of:
defining each frame into a plurality of sub-frames, and numbering each sub-frame according to its corresponding position;
comparing contents of the sub-frames with the same number in the first frame and the second frame;
outputting the content of the variation sub-frame in the second frame and its corresponding number via the first network interface through the network system to the server if the contents are different; and
replacing the content of the sub-frame with the number in the first frame by the received content of the variation sub-frame.

2. The system for real time image transmission monitoring as claimed in claim 1 wherein the network system is the Internet or an area network system.

3. The system for real time image transmission monitoring as claimed in claim 1 further comprising a VGA card to deal with the VGA signal of the client, such that the VGA signal-gathering module can directly gather VGA signals of frames from the VGA card according to time sequence.

4. The system for real time image transmission monitoring as claimed in claim 1 further comprising a first data storage device to store the second frame.

5. The system for real time image transmission monitoring as claimed in claim 1 wherein the first network interface transmits the variation sub-frame and its corresponding number in a packet with a specific format.

6. The system for real time image transmission monitoring as claimed in claim 1 wherein the server comprises:
a second network interface to connect the network system;
a second data storage device to record the updated frame; and
a terminal to display the updated frame in the second data storage device.

7. A remote image monitoring system to use in a network system connecting a server and a client, comprising:
a first network interface to connect with the network system;
a VGA signal-gathering module to gather a first frame and a second frame composed of VGA signals from the client according to time sequence; and
an image signal monitor unit to perform a variation detection operation, the operation comprising the steps of:
defining each frame into a plurality of sub-frames, and numbering each sub-frame according to its corresponding position;
comparing contents of the sub-frames with the same number in the first frame and the second frame;
outputting the content of the variation sub-frame in the second frame and its corresponding number via the first network interface through the network system to the server if the contents are different; and
replacing the content of the sub-frame with the number in the first frame by the received content of the variation sub-frame, thus forming the second frame to output.

8. A method for real time image transmission monitoring to use in a network system connecting a server and a client, comprising the steps of:
gathering a first frame and a second frame composed of VGA signals from the client according to time sequence;
defining each frame into a plurality of sub-frames, and numbering each sub-frame according to its corresponding position;
comparing contents of the sub-frames with the same number in the first frame and the second frame;
outputting the content of the variation sub-frame in the second frame and its corresponding number through the network system to the server if the contents are different; and
replacing the content of the sub-frame with the number in the first frame by the received content of the variation sub-frame.

9. The method for real time image transmission monitoring as claimed in claim 8 further comprising the steps of:
displaying the first frame on the server; and
receiving the content of the variation sub-frame in the second frame and its corresponding number through the network system, thus enabling the server to update and display the second frame in real time.

10. The method for real time image transmission monitoring as claimed in claim 8 further comprising directly gathering VGA signals of frames from a VGA card of the client according to time sequence.
